(19) United States
(12) Patent Application Publication
(10) Pub. No.: US 2007/0265759 A1
(43) Pub. Date: Nov. 15, 2007

(54) METHOD AND SYSTEM FOR UTILIZING TOPOGRAPHICAL AWARENESS IN AN ADAPTIVE CRUISE CONTROL

(76) Inventors: David Salinas, Pflugerville, TX (US); Theodore Jack London Shrader, Austin, TX (US); David Kingsley Clark, Cedar Park, TX (US)

Correspondence Address: IBM CORP (YA);C/O YEE & ASSOCIATES PC, P.O. BOX 802333, DALLAS, TX, 75380, US

(21) Appl. No.: 11/382,323

(22) Filed: May 9, 2006

(51) Int. Cl. B60T 8/32; G06F 17/00

(52) U.S. Cl. 701/93; 701/123

(57) ABSTRACT

A system for an adaptive cruise control system to regulate vehicle fuel consumption. A velocity of a vehicle is monitored in response to receiving a user input to engage the adaptive cruise control system. The velocity is regulated within a velocity bound range in response to monitoring the velocity of the vehicle. An ideal velocity is calculated for the vehicle within the velocity bound range using a plurality of factors. Then the velocity of the vehicle is automatically adjusted to the calculated ideal velocity in advance of a topographical feature in order to regulate fuel consumption of the vehicle.

### BACKGROUND OF THE INVENTION

1. Field of the Invention

The present invention relates generally to an improved adaptive cruise control system for vehicles. More specifically, the present invention is directed to a method, apparatus, and computer useable program code for an adaptive cruise control system to intelligently regulate vehicle fuel consumption by utilizing a plurality of factors.

2. Description of the Related Art:

A cruise control system controls the speed of a vehicle by adjusting the throttle position on the engine. Electronic throttle controllers are well known for operating an engine throttle valve to control the rate of fuel flow to the combustion chamber of an engine. Typically, the throttle controller receives an acceleration input signal from a user or driver of the vehicle via an accelerator pedal. The farther the user depresses the accelerator pedal, the more the throttle valve is opened, which permits more fuel to be consumed by the engine and the vehicle to travel faster.

Some throttle controllers can operate automatically as a “cruise control” to maintain the speed of the vehicle at a cruising speed set by the driver. The cruise control provides a convenient means for a driver to maintain vehicle speed without using foot pedals, which can be especially advantageous on long trips. Typically, such cruise controls use an input from a speedometer or engine speed sensor to monitor the cruising speed of the vehicle.

Factors, such as varying terrain, friction, wind resistance, and the like, cause the automatic cruise control to almost continuously correct for deviations from the user desired or set speed. Consequently, the throttle is constantly fluctuating to allow more or less fuel to be consumed by the engine to maintain the set speed. Sometimes, these fuel fluctuations are abrupt because of rapid changes in speed due to heavy wind gusts or sharp inclines or declines in road topography. These abrupt fuel fluctuations cause inefficient fuel consumption and may create a less than smooth ride for occupants of the vehicle.

Therefore, it would be beneficial to have a method, apparatus, and computer useable program code for an adaptive cruise control system to intelligently regulate a vehicle's engine fuel consumption by utilizing a plurality of factors to thereby improve fuel economy.

### SUMMARY OF THE INVENTION

Illustrative embodiments provide a method, apparatus, and computer usable program code for an adaptive cruise control system to regulate vehicle fuel consumption. A velocity of a vehicle is monitored in response to receiving a user input to engage the adaptive cruise control system. The velocity is regulated within a velocity bound range in response to monitoring the velocity of the vehicle. An ideal velocity is calculated for the vehicle within the velocity bound range using a plurality of factors. Then the velocity of the vehicle is automatically adjusted to the calculated ideal velocity in advance of a topographical feature in order to regulate fuel consumption of the vehicle.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a plurality of systems that may provide data to a vehicle in which an illustrative embodiment may be implemented;

FIG. 2 is a block diagram of an adaptive cruise control system in which an illustrative embodiment may be implemented;

FIG. 3 is a flowchart illustrating an exemplary process for an adaptive cruise control system to regulate vehicle fuel consumption in accordance with an illustrative embodiment;

FIG. 4 is a specific example of comparing adaptive and conventional cruise control systems' vehicle velocity regulation while encountering a topographical feature in accordance with an illustrative embodiment; and

FIGS. 5A and 5B are an exemplary algorithm for vehicle fuel regulation by an adaptive cruise control system in accordance with an illustrative embodiment.

### DETAILED DESCRIPTION OF THE PREFERRED EMBODIMENT

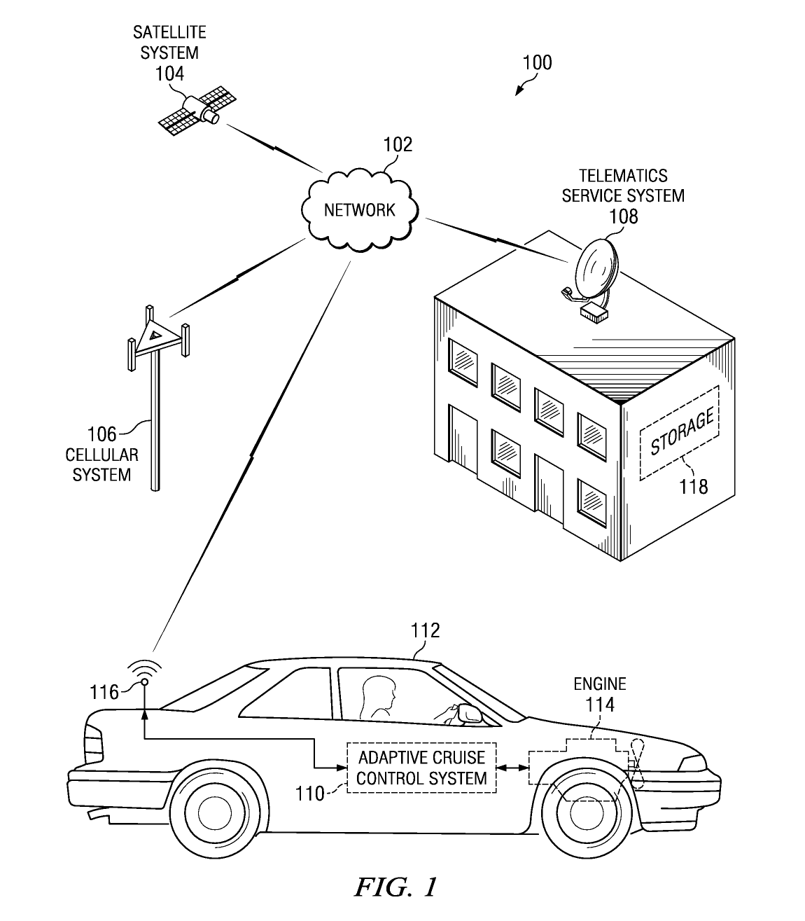

With reference now to the figures and in particular with reference to FIG. 1, a pictorial representation of a plurality of systems that may provide data to a vehicle is depicted in which an illustrative embodiment may be implemented. Plurality of systems 100 is a network of systems in which illustrative embodiments may be implemented. Plurality of systems 100 also may include network 102, which is a medium used to provide communication links between various devices and computers coupled together within plurality of systems 100. Network 102 may include connections, such as wire, wireless communication links, or fiber optic cables.

Plurality of systems 100 may include, for example, satellite system 104, cellular system 106, telematics service system 108, and adaptive cruise control system 110. However, plurality of systems 100 may further include additional systems and devices not shown in this illustration. FIG. 1 is only intended as an example and not as an architectural limitation for different illustrative embodiments.

Vehicle 112 uses plurality of systems 100 to provide data for the intelligent regulation of fuel for engine 114 while encountering a topographical feature. A topographical feature may include, for example, a hill, mountain, valley, or any other change in topography or terrain.

It should be noted that even though vehicle 112 is shown as an automobile in this particular illustration, illustrative embodiments are not restricted to such. Besides an automobile, a vehicle may be, for example, a van, sport utility vehicle, light truck, heavy truck, semi tractor trailer, tractor, train, bus, snowmobile, or any other vehicle that may utilize illustrative embodiments. Also, it should be noted that engine 114 may be any engine type which requires fuel regulation for operation.

Vehicle 112 also includes antenna 116. Vehicle 112 may use antenna 116 to, for example, send and receive data with plurality of systems 100. Antenna 116 is coupled to adaptive cruise control system 110, which in turn is coupled to engine 114. Even though antenna 116 is depicted as an external antenna in this particular illustration, antenna 116 may be, for example, an internal antenna located in a communication unit within adaptive cruise control system 110. Further, it should be noted that any form of wireless communication, such as, for example, radio transmission, microwave transmission, cellular telephone transmission, wireless Web transmission, wireless fidelity (Wi-Fi) transmission, Bluetooth transmission, or any combination thereof, may be employed for communication purposes within and between plurality of systems 100.

Satellite system 104 may be, for example, a network of global positioning system (GPS) satellites. GPS is a satellite-based radio navigation system run by the United States Department of Defense. GPS is designed so that signals from at least four satellites are available anywhere on earth, which are sufficient to compute the current location and elevation of a GPS receiver to within 20 meters. Consequently, vehicle 112 may utilize satellite system 104 to receive location and elevation data of vehicle 112 at any given time via an onboard GPS receiver.

Cellular system 106 may be, for example, a network of regional, national, or global cellular telephone equipment provided by a public or private telecommunications carrier. The cellular telephone equipment may include, for example, a network of cell towers and/or satellites. Vehicle 112 may use cellular system 106 for sending and receiving data, as well as for voice communication purposes. In addition, vehicle 112 may use the network of cellular telephone equipment of cellular system 106 to receive geographic data, such as, for example, current location and elevation of vehicle 112 if necessary. This geographic data provided by cellular system 106 may be utilized, for example, to confirm GPS data received from satellite system 104. In addition, this geographic data provided by cellular system 106 also may provide temporary geographic data input when, for example, data signals from satellite system 104 and telematics service system 108 are not available to vehicle 112.

Telematics service system 108 may be, for example, a network of regional, national, or global telematics service equipment provided by a public or private enterprise. The word telematics is a combination of the words telecommunication and informatics. Informatics, or information science, is the study of the processes involved in the collection, categorization, and distribution of data. A telematics service is one that provides information to a mobile source, such as, for example, a cellular telephone, personal digital assistant (PDA), or vehicle, such as vehicle 112. Presently, telematics often describes vehicle systems that combine GPS, such as satellite system 104, and cellular technologies, such as cellular system 106, with onboard electronics, such as adaptive cruise control system 110.

Telematics service system 108 also may provide information, such as, for example, weather data, traffic, road construction, and safety information, voice communication, vehicle diagnostic capabilities, and entertainment features for vehicle 112. In addition, telematics service system 108 may provide all necessary calculation data for vehicle 112. For example, telematics service system 108 may calculate proper fuel regulation for engine 114 when vehicle 112 approaches a topographical feature.

OnStar® is the most popular telematics service available in North America and is available from the General Motors Corporation. OnStar® is an example of a subscription telematics service that is provided to any customer that owns a factory equipped vehicle for a price. Alternatively, a corporation may utilize telematics service system 108 to send and receive data and communication only with company vehicles.

Further, telematics service system 108 may include storage 118. Telematics service system 108 may employ storage 118 to store vehicle 112 specification data. Specification data for vehicle 112 may include, for example, weight, height, length, width, lift, drag coefficient, two-wheel drive, four-wheel drive, and the like. Vehicle 112 specification data may be utilized for intelligent fuel regulation calculations for engine 114 when vehicle 112 encounters a topographical feature.

Moreover, storage 118 may store previous vehicle 112 travel destinations and fuel regulation calculations for encountered topographical features. Also, storage 118 may include road maps, topographical maps, navigation data, weather information, traffic conditions, road construction sites, safety information, and voice communications. Furthermore, storage 118 may store any data, table, template, and/or algorithm necessary for illustrative embodiments to calculate topographical feature fuel regulation for engine 114. In addition, it should be noted that even though storage 118 is shown within telematics service system 108 in this particular illustration, storage 118 may be located, for example, within an another independent system or within vehicle 112 itself.

Adaptive cruise control system 110 may be, for example, an onboard control and information system located within vehicle 112. In the context of this specification, the term adaptive cruise control means a cruise control that is capable of being automatically adjusted for use in different terrain conditions, such as topographical features. Adaptive cruise control system 110 may include, for example, a plurality of mechanical and electrical components, which are coupled together.

Adaptive cruise control system 110 utilizes a plurality of factors to automatically regulate the velocity of vehicle 112 in advance of when vehicle 112 approaches a topographical feature by regulating fuel to engine 114. The plurality of factors may include, for example, GPS awareness, topographical awareness, destination awareness, weather awareness, and vehicle specification awareness in and around vehicle 112. Of course, illustrative embodiments are not restricted to the use of the above listed factors. Adaptive cruise control system 110 may employ any data, information, and/or factor necessary for processes of illustrative embodiments to calculate proper fuel regulation to engine 114 in advance of a topographical feature.

In the context of this specification, the word awareness means data input from plurality of systems 100 with regard to the respective awareness factor. GPS awareness is data input of location and elevation of vehicle 112. Topographical and destination awareness is data input of the topography or terrain along the route or roadway vehicle 112 is taking to a specific destination.

Weather awareness is data input of weather conditions, such as, for example, rain, ice, snow, and heavy winds along the route or roadway. These weather conditions may negatively affect performance of vehicle 112 and, therefore, may need to be calculated into fuel regulation calculations. The United States Weather Service may, for example, provide weather awareness for vehicle 112 through telematics service system 108. Alternatively, local, regional, national, or global weather services may provide weather awareness to vehicle 112 directly via wireless communication.

Vehicle specification awareness is data input regarding the design parameters of vehicle 112. Vehicle specification awareness, such as vehicle profile data, may be important in fuel regulation calculations during adverse weather conditions, such as high wind speeds. The manufacturer of vehicle 112 may, for example, input the specification data directly into adaptive cruise control system 110 during manufacture. Alternatively, telematics service system 108 may provide the vehicle specification awareness data to vehicle 112 via wireless communication or an owner of vehicle 112 may input the data into adaptive cruise control system 110 via, for example, a liquid crystal display (LCD) with touch screen capabilities located within vehicle 112.

Adaptive cruise control system 110 utilizes these plurality of factors to calculate an ideal vehicle velocity for vehicle 112, within a velocity bound range, when approaching a specific topographical feature that is identified by adaptive cruise control system 110 using, for example, GPS, topographical, and destination awareness factors. In the context of this specification, the term ideal vehicle velocity means the best speed possible for vehicle 112, which conserves fuel through intelligent fuel regulation by adaptive cruise control system 110, when approaching the identified topographical feature. The ideal vehicle velocity is not limited to one particular speed but may include a series of speeds within the velocity bound range. For example, the ideal vehicle velocity may be a series of speeds that produce a smooth, gradual acceleration of vehicle 112 prior to reaching the identified topographical feature, such as a hill. Or, the ideal vehicle velocity may be a series of speeds that produce a smooth, gradual deceleration of vehicle 112 prior to reaching a valley, for example.

The term velocity bound range, in the context of this specification, means a predetermined range of speeds above or below a user set cruise control velocity for vehicle 112. For example, the velocity bound range may be 10 miles per hour (MPH) above or below the user set cruise control speed of 60 MPH. Therefore, the velocity bound range in this particular example is 50-70 MPH, where 50 MPH is the lower velocity limit for the velocity bound range and 70 MPH is the upper velocity limit.

Adaptive cruise control system 110 adjusts the velocity of vehicle 112 within the exemplary velocity bound range of 50-70 MPH when approaching and encountering the identified topographical feature. In other words, adaptive cruise control system 110 does not permit vehicle 112 to exceed the predetermined velocity bound range when encountering the topographical feature during normal operation. However, adaptive cruise control system 110 may be programmed to automatically override the velocity bound range during pre-defined emergency conditions.

The manufacturer of vehicle 112 may, for example, predetermine the velocity bound range by inputting the velocity bound range data into adaptive cruise control system 110 during manufacture. Alternatively, telematics service system 108 may provide the velocity bound range data to vehicle 112 via wireless communication. Or, an owner of vehicle 112 may input the velocity bound range data into adaptive cruise control system 110 via, for example, an LCD with touch screen capabilities located within vehicle 112. It should be noted that the velocity bound range, once predetermined, may be changed at any time according to the desires of the manufacturer, owner, or user to any size velocity bound range.

Further, the manufacturer, owner, or user of vehicle 112 determines an engage distance for adaptive cruise control system 110. In the context of this specification, the term engage distance means a predetermined distance, prior to encountering the identified topographical feature, when adaptive cruise control system 110 engages in intelligent fuel regulation of engine 114 for fuel conservation. For example, the manufacturer, owner, or user of vehicle 112 may set the engage distance at 2 miles. Therefore, in this particular example, adaptive cruise control system 110 engages in intelligent fuel regulation at the exemplary engage distance of 2 miles to prepare vehicle 112 to encounter the identified topographical feature by obtaining the ideal vehicle velocity for the identified topographical feature within the velocity bound range.

Further, the manufacturer, owner, or user of vehicle 112 determines the distance at which adaptive cruise control system 110 identifies topographical features. For example, the manufacturer, owner, or user of vehicle 112 may set the identification of topographical features distance at 3 miles. Consequently, adaptive cruise control system 110, in this particular example, acquires topographical data along the vehicle pathway, which is determined by destination awareness, 3 miles in advance of the location of vehicle 112. The vehicle pathway may be, for example, any type of road, highway, train track, or open terrain. By calculating topographical features in advance of the engage distance, adaptive cruise control system 110 is able to acquire all necessary data from plurality of systems 100 and calculate all necessary calculations for determining the ideal vehicle velocity for vehicle 112, within the velocity bound range, prior to encountering the identified topographical feature.

Therefore, illustrative embodiments provide a method, apparatus, and computer usable program code for an adaptive cruise control system to regulate vehicle fuel consumption. The adaptive cruise control system monitors velocity of the vehicle in response to receiving user input to engage the adaptive cruise control system. The adaptive cruise control system regulates the velocity of the vehicle within the velocity bound range in response to monitoring the velocity. In addition, the adaptive cruise control system calculates the ideal velocity for the vehicle within the velocity bound range using the plurality of factors and automatically adjusts the speed to the calculated ideal velocity in advance of the identified topographical feature. As a result, regulation of engine fuel consumption for the vehicle occurs.

Using illustrative embodiments, vehicle 112 utilizing adaptive cruise control system 110, which calculates the ideal vehicle velocity for an identified topographical feature, may decrease fuel consumption of engine 114 and, therefore, decrease overall fuel costs. In addition, the pro-active nature of adaptive cruise control system 110 provides occupants of vehicle 112 a more comfortable or smoother ride over rough terrain. Furthermore, adaptive cruise control system 110 also may decrease wear and tear on vehicle 112 by decreasing the need for braking and, thus, decrease overall operating and maintenance costs.

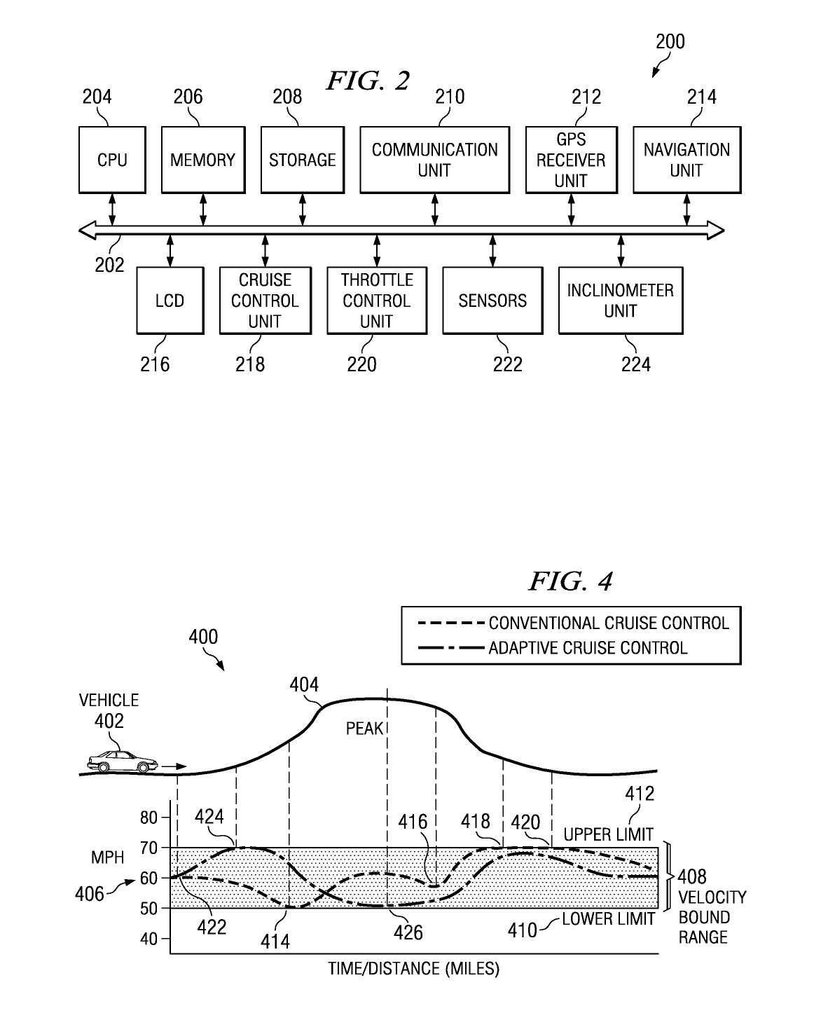

Referring now to FIG. 2, a block diagram of an adaptive cruise control system is shown in which an illustrative embodiment may be implemented. Adaptive cruise control system 200 may be, for example, adaptive cruise control system 110 in FIG. 1. Adaptive cruise control system 200 is an example of an adaptive cruise control system in which computer usable code or instructions implementing illustrative embodiments may be located.

In this depicted example, adaptive cruise control system 200 employs a bus architecture, such as bus 202. Bus 202 may comprise one or more buses. In addition, bus 202 may be implemented using any type of communication fabric or architecture that provides for a transfer of data between different components or devices attached to the fabric or architecture.

Adaptive cruise control system 200 may include, for example, central processing unit (CPU) 204, memory 206, and storage 208, which are coupled to bus 202. CPU 204 provides the data processing capabilities of adaptive cruise control system 200. An operating system runs on CPU 204 and coordinates and provides control of various components within adaptive cruise control 200. An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

Instructions for the operating system, the object-oriented programming system, and applications or programs are located on a storage device, such as storage 208, and may be loaded into memory 206 for execution by CPU 204. The processes for illustrative embodiments are performed by CPU 204 using computer usable program code, which may be located in a memory such as, for example, memory 206 or in one or more peripheral devices.

Those of ordinary skill in the art will appreciate that the hardware in FIG. 2 may vary depending on the implementation. Other internal hardware or peripheral devices, such as flash memory, equivalent non-volatile memory, or optical disk drives and the like, may be used in addition to or in place of the hardware depicted in FIG. 2. Also, the processes of illustrative embodiments may be applied to a multiprocessor adaptive cruise control system.

In addition to storing instructions for the operating system, the object-oriented programming system, and applications or programs, storage 208 may store, for example, any and all data necessary for CPU 204 to calculate the ideal vehicle velocity for a vehicle, such as vehicle 112 in FIG. 1, within the velocity bound range when approaching an identified topographical feature along the vehicle pathway to thereby conserve fuel. For example, storage 208, such as storage 118 in FIG. 1, may store vehicle specification data, previous vehicle travel data, road maps, topographical maps, and navigation data, along with any other data, table, template, and/or algorithm necessary for illustrative embodiments to calculate topographical feature fuel regulation.

Examples of templates, which may be utilized by adaptive cruise control system 200, are: 1) when adaptive cruise control system 200 is engaged in a designated construction or frequently congested zone, a warning signal or display is provided to the user indicating that cruise control is not recommended at this time; 2) provide a warning signal or display 2 miles before entering a designated construction or frequently congested zone and give a 10 second countdown to cancel cruise control; and 3) if the vehicle has a manual transmission, such as an 18-wheeler, and is approaching an identified topographical feature, such as a steep grade, display a recommendation to drop down 2 gears. Of course, the above listed templates are only for illustration purposes and are not meant to be restriction on illustrative embodiments. Any template or combinations of templates may be employed, which allow processes of illustrative embodiments to intelligently regulate fuel to an engine, such as engine 114 in FIG. 1.

Further, adaptive cruise control system 200 may include, for example, communication unit 210, GPS receiver unit 212, navigation unit 214, and LCD 216 coupled to bus 202. Adaptive cruise control system 200 uses communication unit 210 to wirelessly communicate with a network of different system, such as plurality of systems 100 in FIG. 1. Communication unit 210 may include one or more devices used to transmit and receive data. For example, communication unit 210 may include a cellular telephone and/or an antenna, such as antenna 116 in FIG. 1, to send and receive wireless transmissions.

Adaptive cruise control system 200 utilizes GPS receiver unit 212 for obtaining vehicle location and elevation data from GPS satellites, such as satellite system 104 in FIG. 1, for GPS awareness. Adaptive cruise control system 200 may employ navigation unit 214 to obtain route and terrain data for topographical and destination awareness. Navigation unit 214 may include, for example, a compact disc read only memory (CD-ROM) drive to read compact discs containing local, regional, or national road and topographical data. Alternatively, navigation unit 214 may obtain this map data from a telematics service, such as telematics service system 108 in FIG. 1. Adaptive cruise control system 200 also may use navigation unit 214 to recommend alternate routes to a destination, which may cause less engine fuel consumption.

Navigation unit 214 also may include an LCD to display route and topographical information to the user. Alternatively, navigation unit 214 may use LCD 216 to display route and topographical information to the user. Adaptive cruise control system 200 also uses LCD 216 to display other information and warnings to the user. LCD 216 has touch screen capabilities for user data input.

Furthermore, adaptive cruise control system 200 also includes cruise control unit 218, throttle control unit 220, and sensors 222 coupled to bus 202. Cruise control unit 218 includes a plurality of user controls. The user cruise controls may include, for example: an on/off switch for engaging and disengaging the adaptive cruise control system; a cancel switch for canceling cruise control operation; a set/coast switch for setting cruise control operation during a non-cruise control operation as well as automatically decelerating the vehicle during a cruise control operation; and a resume/acceleration switch for automatically resuming the vehicle to cruise during a non-cruise control operation as well as accelerating the vehicle during a cruise control operation.

Adaptive cruise control system 200 utilizes cruise control unit 218 to regulate throttle control unit 220. Throttle control unit 220 regulates the throttle valve, which controls the amount of fuel entering the engine's combustion chamber. As a result, the throttle valve controls the power and speed of the engine, which in turn controls the velocity of the vehicle.

Adaptive cruise control system 200 employs sensors 222 to provide the system with information regarding the vehicles operation. For example, sensors 222 may include a brake sensor for determining brake use. Also, sensors 222 may include a clutch sensor for determining use of the clutch. Use of the vehicle's clutch or braking system requires cancellation of cruise control operation. In addition, sensors 222 may include a speed sensor to provide adaptive cruise control system 200 with accurate vehicle velocity data. Consequently, sensors 222 are important to adaptive cruise control system 200 for providing vital operation data for the vehicle. Of course, illustrative embodiments are not limited to only brake, clutch, and speed sensors. Illustrative embodiments may use any type sensor necessary for the proper operation of adaptive cruise control system 200.

Additionally, adaptive cruise control unit 200 also may include inclinometer unit 224. Adaptive cruise control unit 200 uses inclinometer unit 224 to obtain data regarding the vehicle's orientation, such as going uphill or downhill. Inclinometer 224 may be utilized, for example, to confirm topographical awareness data and/or provide temporary topographical data input when GPS and/or telematics service signals are not available.

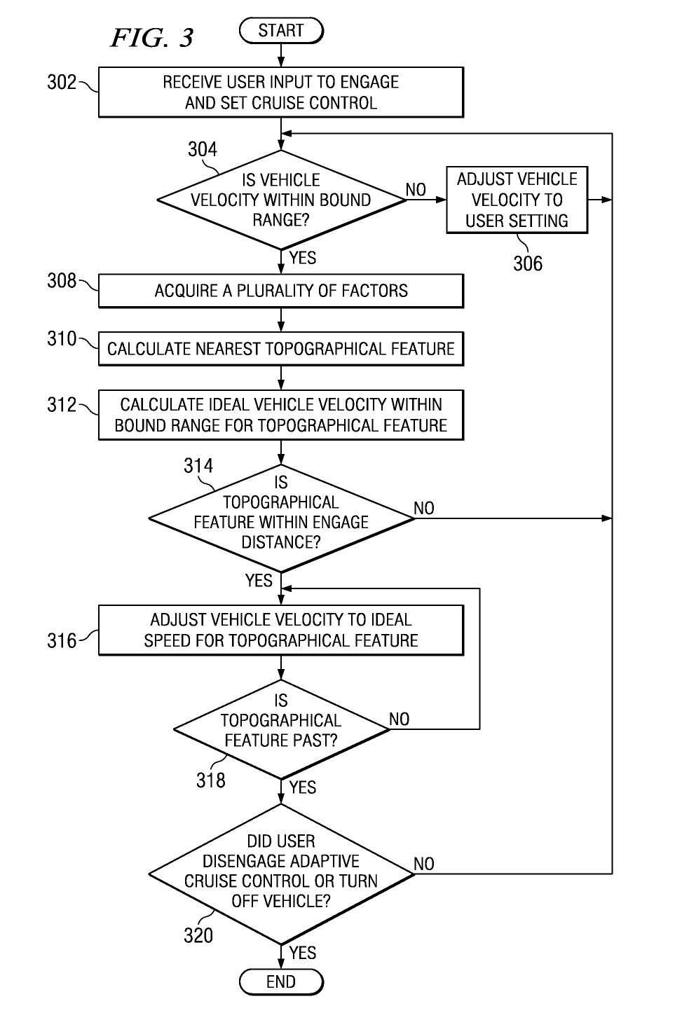

Turning now to FIG. 3, a flowchart illustrating an exemplary process for an adaptive cruise control system to regulate vehicle fuel consumption is depicted in accordance with an illustrative embodiment. The process depicted in FIG. 3 may be implemented in an adaptive cruise control system, such as adaptive cruise control system 110 in FIG. 1.

The process begins when the adaptive cruise control system receives a user input to engage a cruise control unit, such as cruise control unit 218 in FIG. 2, and set a desired cruise control velocity or speed for a vehicle, such as vehicle 112 in FIG. 1 (step 302). Subsequent to receiving the user input to engage and set cruise control in step 302, the adaptive cruise control system makes a determination as to whether the speed of the vehicle is within a velocity bound range (step 304). If the speed of the vehicle is not within the velocity bound range, no output of step 304, then the adaptive cruise control system adjusts the velocity of the vehicle to the desired user cruise control speed setting (step 306).

After adjusting the velocity of the vehicle to the desired user cruise control speed setting in step 306, the process returns to step 304 where the adaptive cruise control system makes a determination as to whether the speed of the vehicle is within a velocity bound range. If the speed of the vehicle is within the velocity bound range, yes output of step 304, then the adaptive cruise control system acquires a plurality of factors, such as, for example, GPS, topographical, destination, weather, and vehicle specification awareness (step 308). Subsequent to acquiring the plurality of factors in step 308, the adaptive cruise control system calculates or identifies the nearest topographical feature (step 310).

Then the adaptive cruise control system calculates an ideal vehicle velocity, within the velocity bound range, for the identified topographical feature using the plurality of factors acquired in step 308 (step 312). After calculating the ideal vehicle velocity in step 312, the adaptive cruise control system makes a determination as to whether the identified topographical feature is within an engage distance (step 314). If the identified topographical feature is not within the engage distance, no output of step 314, then the process returns to step 304 where the adaptive cruise control system makes a determination as to whether the speed of the vehicle is within the velocity bound range. If the identified topographical feature is within the engage distance, yes output of step 314, then the adaptive cruise control system adjusts the speed to the ideal vehicle velocity for the identified topographical feature (step 316).

Subsequent to adjusting the speed to the ideal vehicle velocity for the identified topographical feature in step 316, the adaptive cruise control system makes a determination as to whether the identified topographical feature is past (step 318). If the identified topographical feature is not past, no output of step 318, then the process returns to step 316 where the adaptive cruise control system adjusts the speed to the ideal vehicle velocity for the identified topographical feature. If the identified topographical feature is past, yes output of step 318, then the adaptive cruise control system makes a determination as to whether the adaptive cruise control system receives a user input to disengage the adaptive cruise control system or the vehicle is turned off (step 320). If the adaptive cruise control system does not receive a user input to disengage the adaptive cruise control system and the vehicle is not turned off, no output of step 320, then the process returns to step 304 where the adaptive cruise control system makes a determination as to whether the speed of the vehicle is within the velocity bound range. If the adaptive cruise control system does receive a user input to disengage the adaptive cruise control system or the vehicle is turned off, yes output of step 320, then the process terminates thereafter.

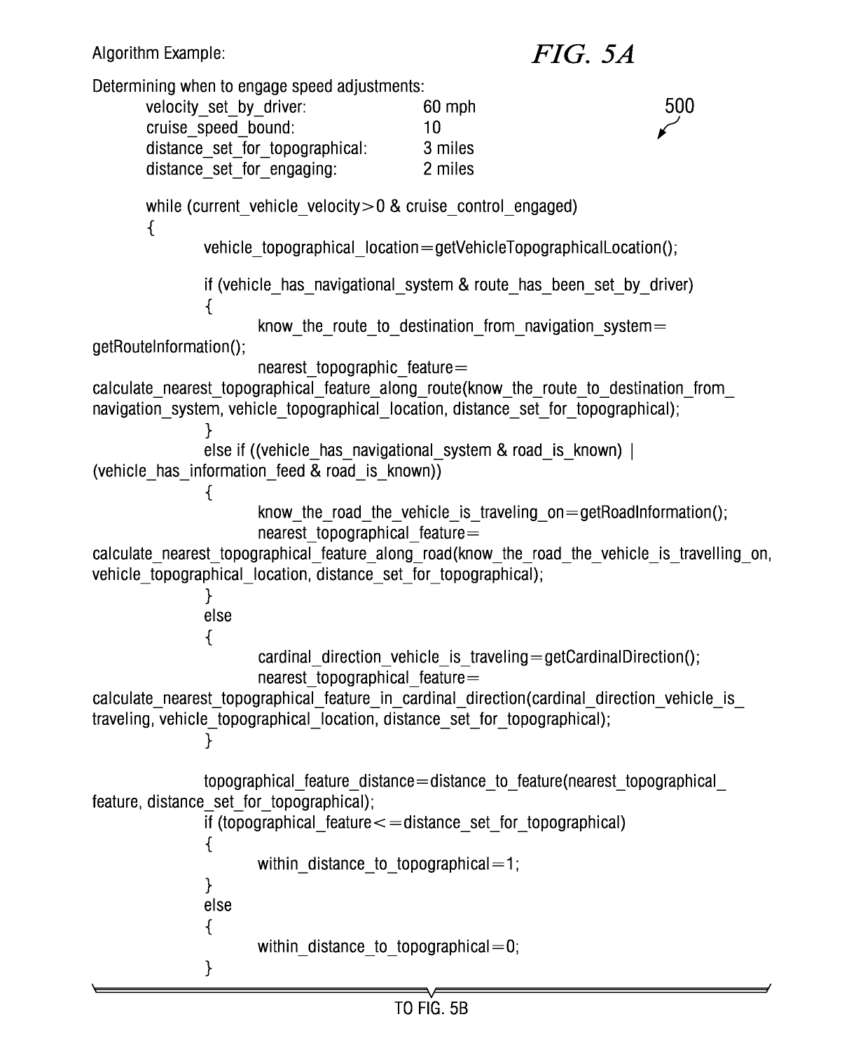

With reference now to FIG. 4, a specific example of comparing adaptive and conventional cruise control systems' vehicle velocity regulation while encountering a topographical feature is shown in accordance with an illustrative embodiment. Comparison example 400 compares the speed regulation of a vehicle using an adaptive cruise control system, such as adaptive cruise control system 200 in FIG. 2, with a vehicle using a conventional cruise control system. Comparison example 400 includes vehicle 402, such as vehicle 112 in FIG. 1, and topographical feature 404, which is a hill with a moderately steep incline and decline.

User set cruise control speed 406 for the adaptive and conventional cruise control systems is 60 MPH in this particular example. Velocity bound range 408 is the same for both the adaptive and conventional cruise control systems. Velocity bound range 408 includes lower velocity limit 410 and upper velocity limit 412. In this particular example, lower velocity limit 410 is 50 MPH and upper velocity limit 412 is 70 MPH. Consequently, the speed of vehicle 402 is maintained between lower velocity limit 410 and upper velocity limit 412 while encountering topographical feature 404 for both the adaptive and conventional cruise control systems.

With regard to using the convention cruise control system, vehicle 402 may start increasing speed to maintain user set cruise control speed 406 well after encountering the incline side of topographical feature 404 at point 414. As a result, vehicle 402 initially looses speed to lower velocity limit 410 and then accelerates to user set cruise control speed 406 at point 416. However, by the time vehicle 402 reaches user set cruise control speed 406, vehicle 402 may be on the decline side of topographical feature 404 causing vehicle 402 to continue to increase speed to upper velocity limit 412 at point 418. Then, vehicle 402 has to coast or brake to resume user set cruise control speed 406 after point 420. Thus, fuel consumption may be increased and occupant comfort decreased due to the reactive nature of the conventional cruise control system while encountering topographical feature 404.

With regard to using the adaptive cruise control system, vehicle 402 may start increasing speed to prepare to encounter identified topographical feature 404 in advance at point 422. Vehicle 402 identifies the topographical feature by utilizing a plurality of factors acquired from a plurality of systems, such as plurality of systems 100 in FIG. 1. Vehicle 402 continues to accelerate until a calculated ideal vehicle velocity for the incline side of topographical feature 404 is obtained at point 424. The adaptive cruise control system for vehicle 402 uses a processor, such as CPU 204 in FIG. 2, to calculate the ideal vehicle velocity by utilizing the plurality of factors. By using the pro-active nature of the adaptive cruise control system, vehicle 402 is able to smoothly increase speed to an ideal vehicle velocity prior to topographical feature 404 and smoothly decrease speed until reaching point 426, which represents the peak of topographical feature 404. Then, the adaptive cruise control system obtains the ideal vehicle velocity for the decline side of topographical feature 404, which factors in the declination and natural velocity build-up, by gradually increasing speed until user set cruise control speed 406 is obtained without coasting or braking. As a result, fuel consumption may be decreased and occupant comfort increased due to the pro-active nature of the adaptive cruise control system while encountering topographical feature 404.

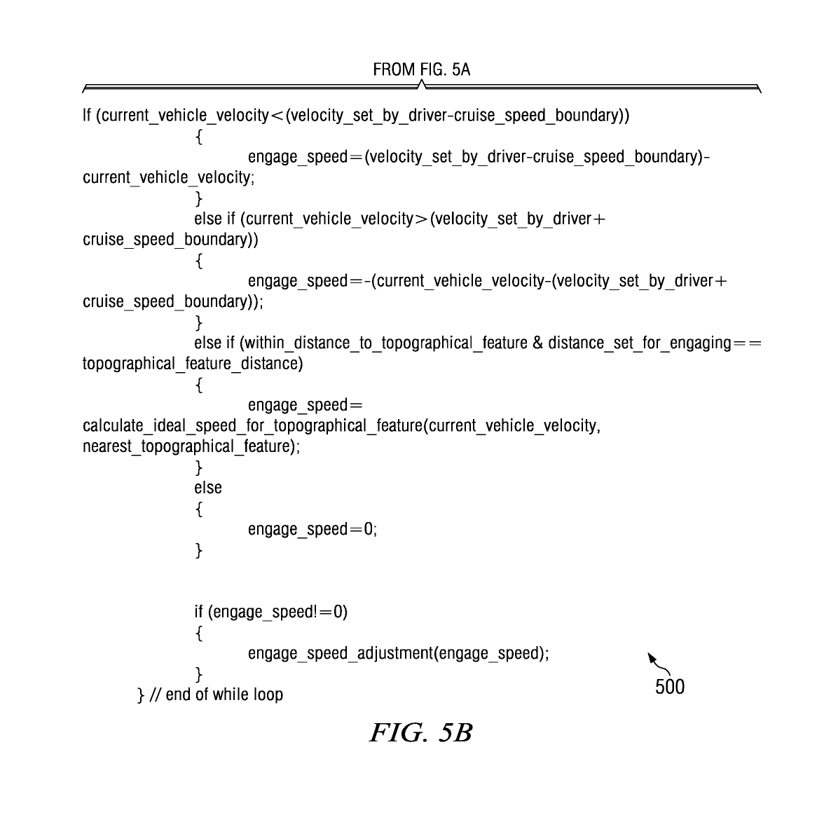

Referring now to FIGS. 5A and 5B, an exemplary algorithm for vehicle fuel regulation by an adaptive cruise control system is depicted in accordance with an illustrative embodiment. The exemplary fuel regulating algorithm for the adaptive cruise control system, such as adaptive cruise control system 200 in FIG. 2, may be located in storage, such as adaptive cruise control system storage 208 in FIG. 2 and/or telematics service system storage 118 in FIG. 1. Algorithm 500 is only presented as an example of an algorithm that may be utilized by illustrative embodiments to regulate fuel consumption of a vehicle, such as vehicle 402 in FIG. 4, while encountering an identified topographical feature, such as topographical feature 404 in FIG. 4. Illustrative embodiments are not limited to the use of algorithm 500. Any algorithm capable of regulating fuel consumption of a vehicle using an adaptive cruise control system may be employed by illustrative embodiments.

Thus, illustrative embodiments provide an adaptive cruise control system to regulate vehicle fuel consumption. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and wireless Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for an adaptive cruise control system to regulate vehicle fuel consumption, the method comprising:
responsive to receiving a user input to engage the adaptive cruise control system, monitoring a velocity of a vehicle;
responsive to monitoring the velocity of the vehicle, regulating the velocity within a velocity bound range;
calculating an ideal velocity for the vehicle within the velocity bound range using a plurality of factors to form a calculated ideal velocity; and
adjusting the velocity of the vehicle automatically to the calculated ideal velocity in advance of a topographical feature to regulate fuel consumption of the vehicle.

2. The method of claim 1, further comprising:
calculating a distance to the topographical feature.

3. The method of claim 2, wherein the velocity of the vehicle is automatically adjusted to the calculated ideal velocity if the distance to the topographical feature is within an engage distance.

4. The method of claim 1, wherein the plurality of factors are used to determine topographical feature awareness.

5. The method of claim 1, wherein the plurality of factors include global positioning system awareness, topographical awareness, and destination awareness.

6. The method of claim 5, wherein the plurality of factors further includes weather awareness and vehicle specification awareness.

7. The method of claim 4, wherein the topographical feature awareness includes degree of inclination of the vehicle, and wherein the degree of inclination is provided by an inclinometer unit.

8. The method of claim 4, wherein the topographical feature awareness is used to determine the location of the topographical feature.

9. The method of claim 8, wherein the topographical feature is at least one of an incline or decline in a terrain of a vehicle pathway.

10. The method of claim 9, wherein the vehicle pathway is at least one of a road, highway, train track, or open terrain.

11. The method of claim 1, wherein the vehicle is one of an automobile, van, sport utility vehicle, light truck, heavy truck, semi tractor trailer, tractor, train, or bus.

12. The method of claim 1, wherein the velocity bound range includes an upper velocity limit and a lower velocity limit.

13. A data processing system for an adaptive cruise control system to regulate vehicle fuel consumption, comprising:
a bus system;
a storage device connected to the bus system, wherein the storage device includes a set of instructions; and
a processing unit connected to the bus system, wherein the processing unit executes the set of instructions to monitor a velocity of a vehicle in response to receiving a user input to engage the adaptive cruise control system, regulate the velocity within a velocity bound range in response to monitoring the velocity of the vehicle, calculate an ideal velocity for the vehicle within the velocity bound range using a plurality of factors to form a calculated ideal velocity, and adjust the velocity of the vehicle automatically to the calculated ideal velocity in advance of a topographical feature to regulate fuel consumption of the vehicle.

14. The data processing system of claim 13, wherein the processing unit executes a further set of instructions to calculate a distance to the topographical feature.

15. A computer program product for an adaptive cruise control system to regulate vehicle fuel consumption, the computer program product comprising:
a computer usable medium having computer usable program code embodied therein, the computer usable medium comprising:
computer usable program code configured to monitor a velocity of a vehicle in response to receiving a user input to engage the adaptive cruise control system;
computer usable program code configured to regulate the velocity within a velocity bound range in response to monitoring the velocity of the vehicle;
computer usable program code configured to calculate an ideal velocity for the vehicle within the velocity bound range using a plurality of factors to form a calculated ideal velocity; and
computer usable program code configured to adjust the velocity of the vehicle automatically to the calculated ideal velocity in advance of a topographical feature to regulate fuel consumption of the vehicle.

16. The computer program product of claim 15, further comprising:
computer usable program code configured to calculate a distance to the topographical feature.

17. The computer program product of claim 16, wherein the velocity of the vehicle is automatically adjusted to the calculated ideal velocity if the distance to the topographical feature is within an engage distance.

18. The computer program product of claim 15, wherein the plurality of factors are used to determine topographical feature awareness.

19. The computer program product of claim 15, wherein the plurality of factors include global positioning system awareness, topographical awareness, and destination awareness.

20. The computer program product of claim 19, wherein the plurality of factors further includes weather awareness and vehicle specification awareness.
